(19) United States
(12) Patent Application Publication
(10) Pub. No.: US 2024/0251417 A1
(43) Pub. Date: Jul. 25, 2024

(54) PROCEDURE DESIGN FOR SELECTION BETWEEN SHARED DISCOVERY POOL AND DEDICATED POOL

(71) Applicant: QUALCOMM Incorporated, San Diego, CA (US)

(72) Inventors: Peng CHENG, Beijing (CN); Qing LI, Princeton Junction, NJ (US); Karthika PALADUGU, Hyderabad (IN); Seyedkianoush HOSSEINI, San Diego, CA (US); Hong CHENG, Basking Ridge, NJ (US)

(21) Appl. No.: 18/563,766

(22) PCT Filed: Jul. 15, 2021
(86) PCT No.: PCT/CN2021/106392

§ 371 Date: Nov. 22, 2023

(51) Int. Cl. H04W 72/21; H04W 28/02; H04W 72/563

(52) U.S. Cl. CPC H04W 72/21; H04W 28/0278; H04W 72/563

(57) ABSTRACT

Method and apparatus for selection between shared discovery pool and dedicated pool. The apparatus receives, from a UE, a BSR or at least one SR, where the BSR or the at least one SR correspond to at least one of data traffic or discovery signaling. The apparatus configures an uplink grant using shared pool of resources or dedicated pool of resources based at least on the BSR or the at least one SR. The apparatus transmits the uplink grant to the UE.

### TECHNICAL FIELD

The present disclosure relates generally to communication systems, and more particularly, to a configuration for selection between shared discovery pool and dedicated pool.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a base station. The device may be a processor and/or a modem at a base station or the base station itself. The apparatus receives, from a user equipment (UE), a buffer status report (BSR) or at least one scheduling request (SR), wherein the BSR or the at least one SR correspond to at least one of data traffic or discovery signaling. The apparatus configures an uplink grant using shared pool of resources or dedicated pool of resources based at least on the BSR or the at least one SR. The apparatus transmits the uplink grant to the UE.

In an aspect of the disclosure, a method, a computer-readable medium, and an apparatus are provided. The apparatus may be a device at a UE. The device may be a processor and/or a modem at a UE or the UE itself. The apparatus transmits, to a base station, a buffer status report (BSR) or at least one scheduling request (SR), wherein the BSR or the at least one SR correspond to at least one of data traffic or discovery signaling. The apparatus receives, from the base station, an uplink grant using shared pool of resources or dedicated pool of resources based at least on the BSR or the SR. The apparatus communicates with a wireless device based on the uplink grant.

In an aspect of the disclosure, a method, a computer-readable medium, and an apparatus are provided. The apparatus may be a device at a UE. The device may be a processor and/or a modem at a UE or the UE itself. The apparatus receives, from a base station, a logical channel prioritization (LCP) configuration. The apparatus allocates resources for sidelink transmission based on the LCP configuration, wherein allocated resources for the sidelink transmission are comprised of shared pool of resources or dedicated pool of resources. The apparatus communicates with a wireless device based on allocated resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A illustrates an example of sidelink communication system.

FIG. 4B illustrates an example of sidelink communication system.

FIG. 5 illustrates an example of a BSR format.

FIG. 6 illustrates an example of a discovery BSR.

FIG. 7 is a call flow diagram of signaling between a UE and a base station.

FIG. 8 is a call flow diagram of signaling between a UE and a base station.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a flowchart of a method of wireless communication.

FIG. 13 is a flowchart of a method of wireless communication.

FIG. 14 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

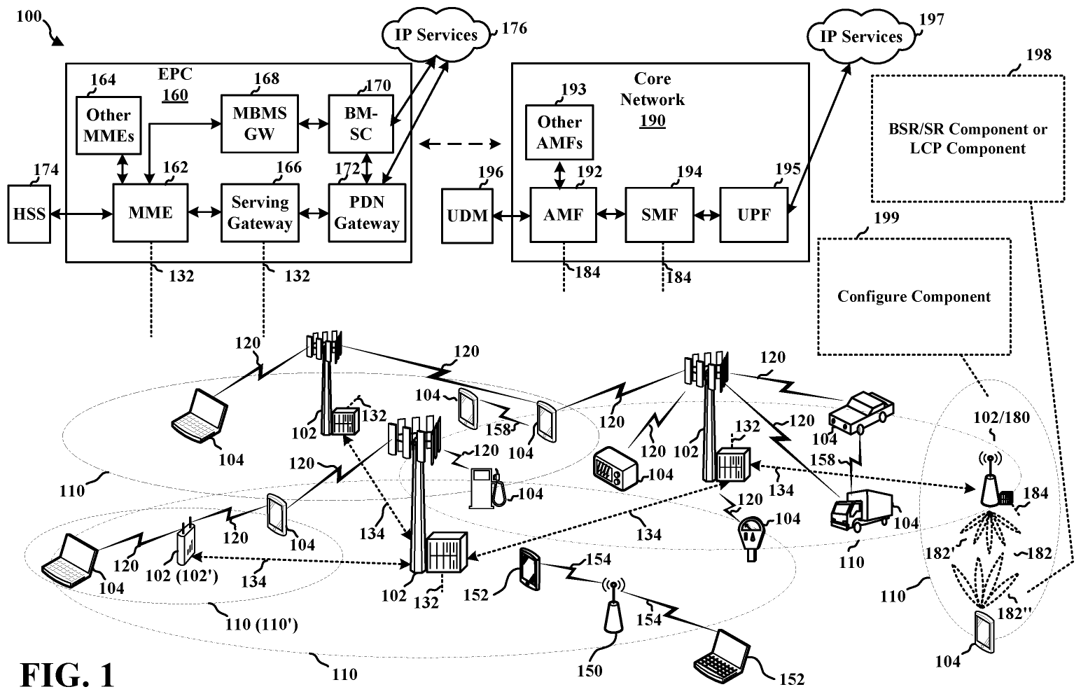

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive allocated resources from a base station 180 using shared pool of resources or dedicated pool of resources based at least on BSR or SR. For example, the UE 104 may comprise a BSR/SR component or LCP component 198 configured to receive allocated resources from a base station 180 using shared pool of resources or dedicated pool of resources based at least on BSR or SR. In certain aspects, the UE 104 may be configured to allocate resources autonomously for sidelink transmission from shared pool or dedicate pool of resources based on an LCP configuration. For example, the UE 104 may comprise BSR/SR component or LCP component 198 configured to allocate resources autonomously for sidelink transmission from shared pool or dedicate pool of resources based on an LCP configuration.

Referring again to FIG. 1, in certain aspects, the base station 180 may be configured to allocate resources for a UE 104 using shared pool of resources or dedicated pool of resources based at least on BSR or SR. For example, the base station 180 may comprise a configure component 199 configured to allocate resources for a UE 104 using shared pool of resources or dedicated pool of resources based at least on BSR or SR.

Although the following description may be focused on 5G NR, the concepts described herein may be applicable to other similar areas, such as LTE, LTE-A, CDMA, GSM, and other wireless technologies.

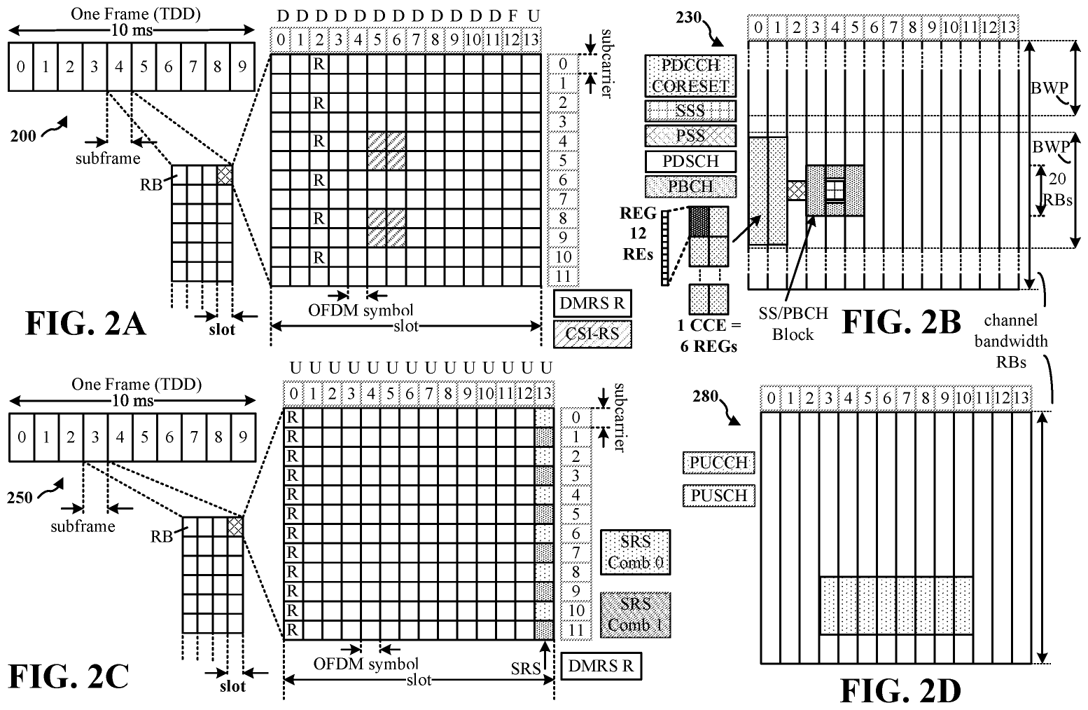

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

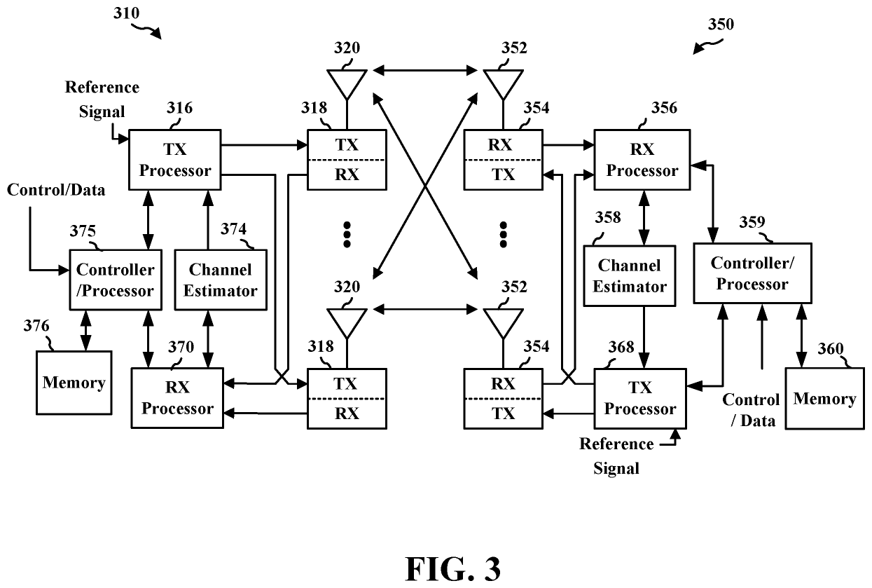

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

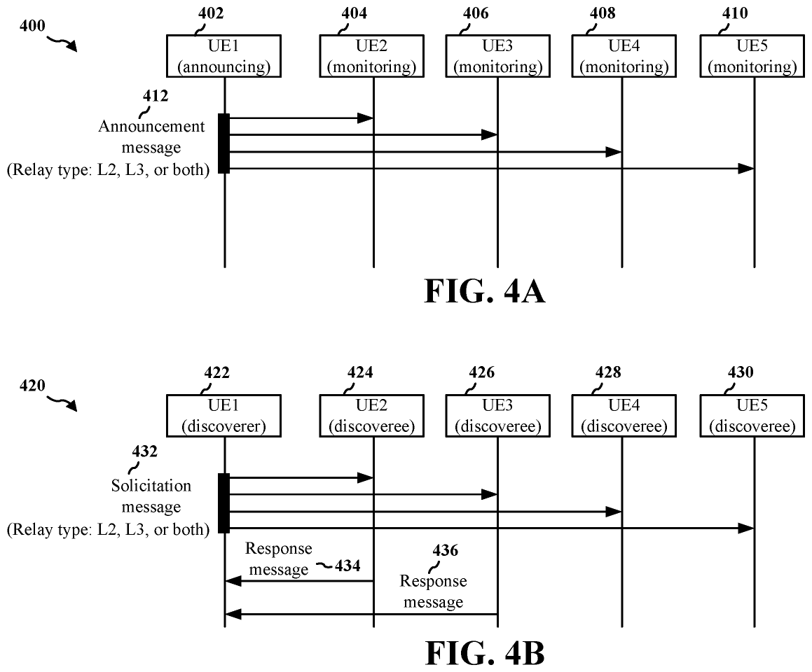

In wireless communication systems, for example sidelink communication systems, a Model A/B discovery model may be reused for UE to network (U2N) relay. For example, discovery messages may be carried over SL SRB with a control plane protocol stack similar to PC5-S(e.g., PC5-S, PDCP, RLC, MAC, PHY). No ciphering and integrity protection are in the PDCP layer. The SDU type filed is not used, and the layer 2 identifier design is left to SA2. For example, with reference to the diagram 400 of FIG. 4A, the UE1 402 may transmit an announcement message 412 to one or more UEs (e.g., 404, 406, 408, 410) as part of a Model A discovery model. In the example of diagram 420 of FIG. 4B, the UE1 422 may transmit a solicitation message 432 to one or more UEs (e.g., 424, 426, 428, 430) as part of a Model B discovery model. In some instances, a UE (e.g., UE2 424) may respond to the solicitation message 432 with a response message 434, while another UE (e.g., UE3 426) may respond to the solicitation message 432 with a response message 436.

The discovery resource pool for sidelink may include separate discover physical channels (e.g., such as PDSCH in LTE). The relay discovery/announcement may be carried over physical sidelink shared channel (PSSCH). Both separate and shared resource pools may be supported for discovery. A logical channel identifier (LCID) may be utilized for the discovery message. In addition, a sidelink signaling radio bearer (SL-SRB) may be utilized having a fixed logical priority and a fixed configuration. A separate resource pool and a shared resource pool may each have advantages as well as disadvantages. For example, a separate resource pool may cause resource utilization inefficiency, while a shared resource pool may have resource utilization efficiency but the cost is that the PHY mechanism may be required to avoid collision between discovery and communication. With regards to UE power savings, for the separate resource pool the receiving UE may reduce monitoring because the separate resource pool implicitly differentiates the discovery message, while for the shared resource pool, an enhancement to differentiate the PHY may be needed in order to realize improved power savings. With regards to power control, the separate resource pool may include separate power saving schemes for communication and discovery, while for shared resource pool, power control may not be enhanced because a power control scheme may not be performed per message in a same resource pool. For measurement for relay re/selection, for separate resource pool, the remote UE may filter discover for PC5 RSRP measurement because the separate pool implicitly differentiates the discovery message, while for the share resource pool, enhancement to differentiate the PHY may be needed in order for PC5 RSRP measurements. The separate resource pool does not have an impact with regard to RAN1, while the shared resource pool, may have a potential impact on RAN1 to differentiate a solution in PHY for power/measurement enhancements.

The dedicated resource pool may be supported in addition to the shared resource pool. However, there exists a need to further define the manner in which the dedicated resource pool or the shared resource pool are selected. Aspects presented herein provide a configuration for determining whether to use the dedicated pool or the shared pool. For example, in some instances such as mode 1 resource allocation, the selection of the dedicated pool or the shared pool may be based on a BSR configured to differentiate the buffer size between a discover message and data traffic. In some instances, such as mode 1 resource allocation, the selection of the dedicated pool or the shared pool may be based on a scheduling request configured to provide information on discovery priority. In yet some instances, such as mode 2 resource allocation, the UE may be configured to prioritize the selection of the dedicated resource pool having discover logical channels over the shared resource pool having non-discovery logical channels.

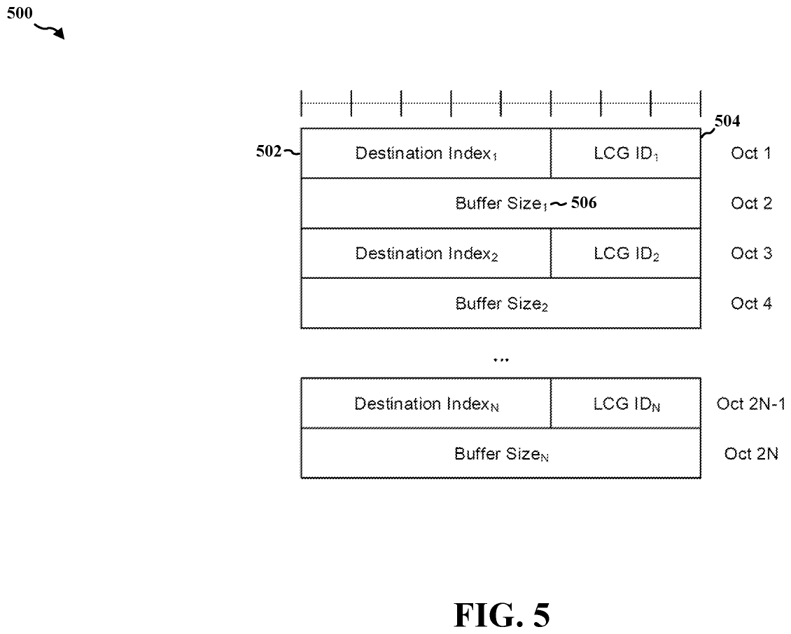

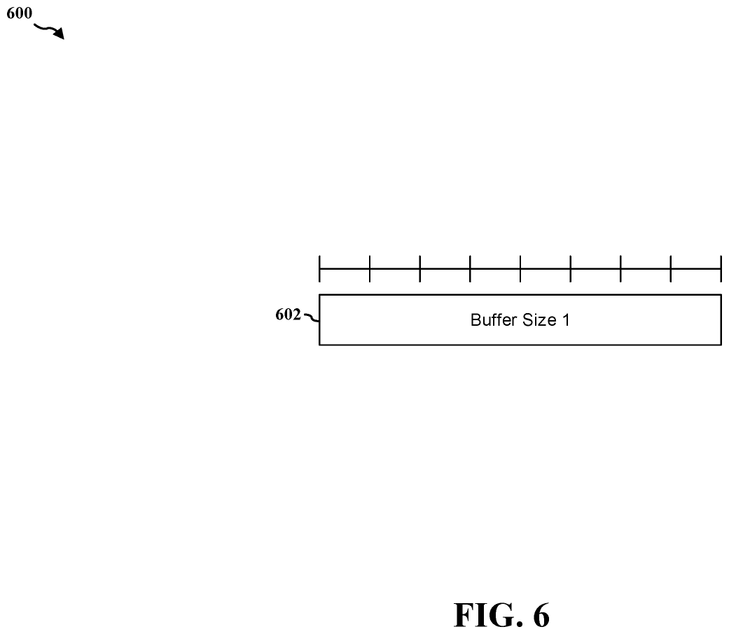

FIG. 5 is an example 500 of a BSR format. In some instances, the selection of the dedicated pool or shared pool may be based on a BSR and/or an SR. For example, the network may be configured to perform the selection between the dedicated pool or the shared pool to deliver the discovery message. In some aspects, the UE may be configured to perform the selection between the dedicated pool or the shared pool to deliver the discovery message. In some aspects, the BSR may be configured to differentiate a buffer size of the discovery message and data traffic, such that the network (e.g., base station) may allocate resources for the discovery resource. In some aspects, a logical channel group (LCG) (e.g., 504) may be configured to indicate that the buffer size (e.g., 506) may correspond to a discovery message. The LCG may have a fixed identifier or may the identifier may be configured (e.g., via RRC). In some aspects, the BSR may be configured to correspond to a discovery message. For example, the BSR may comprise a fixed logical channel identifier (LCID). The BSR may comprise a format having only one field of buffer size 602, such that the logical channel of the discovery is fixed, for example as shown in the example 600 of FIG. 6.

In some aspects, the SR may be configured to correspond to the discovery message and provide more priority information for discovery, such that the network (e.g., base station) may determine whether to use dedicated or shared resource pool. In some aspects, the UE may be configured with at least one SR associated with the logical channel of discovery. In some aspects, two or more SR configuration may be associated with the logical channel of discovery, where different SRs are configured with different priority via RRC signaling. The dedicated pool may be sparse, such that discovery may take longer if the dedicated pool is used. As such, the base station may use the shared pool for instances of high priority discovery.

In some aspects, the AMF may forward the discovery destination identifier (e.g., 502) to the NG-RAN via a next gen application protocol (NGAP) message, and the base station may determine whether the BSR is for discovery or data traffic based on the sidelink (SL) destination ID in the SL-BSR. The discovery destination ID may comprise one or more destination IDs. If the discovery destination ID has more than one, different destination IDs may be assigned for different priority for discovery. In some instances, the destination ID may be updated during a configuration update procedure triggered by a UE policy association establishment or a UE policy association modification.

In some instances, the dedicate pool for discovery may include a logical channel prioritization (LCP) configuration, such that the discovery logical channel may not be multiplexed with other non-discovery logical channels in the dedicated resource pool. For example, discovery logical channels may be transmitted separately from non-discovery logical channels in the dedicated resource pool. In some aspects, the UE may be configured to prioritized the selection of the dedicated resource pool with the discovery logical channels over the shared pool having non-discovery logical channels.

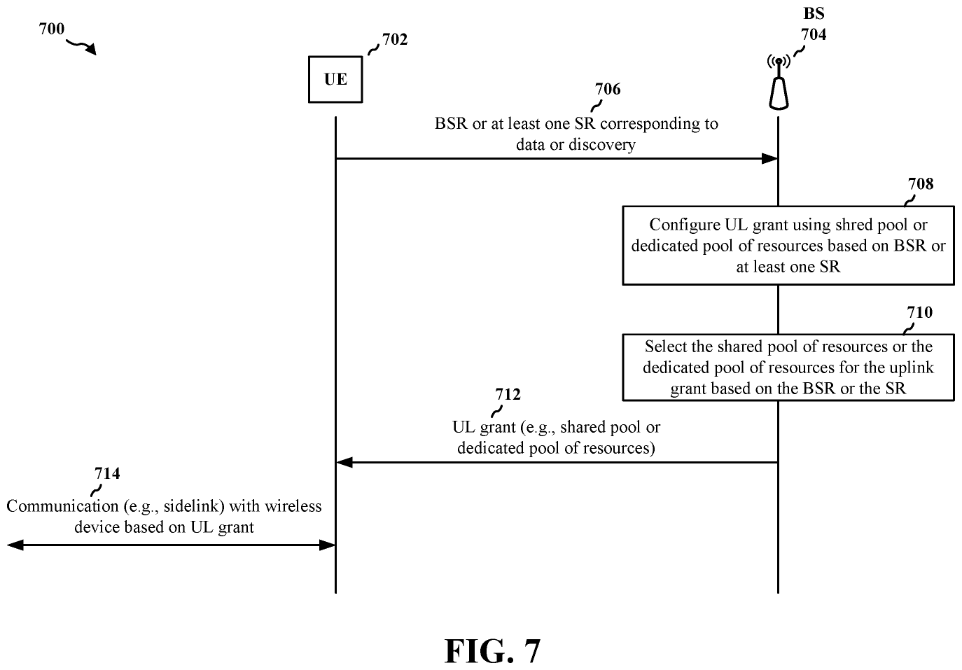

FIG. 7 is a call flow diagram 700 of signaling between a UE 702 and a base station 704. The base station 704 may be configured to provide at least one cell. The UE 702 may be configured to communicate with the base station 704. For example, in the context of FIG. 1, the base station 704 may correspond to base station 102/180 and, accordingly, the cell may include a geographic coverage area 110 in which communication coverage is provided and/or small cell 102′ having a coverage area 110′. Further, a UE 702 may correspond to at least UE 104. In another example, in the context of FIG. 3, the base station 704 may correspond to base station 310 and the UE 702 may correspond to UE 350.

As illustrated at 706, the UE 702 may transmit a BSR or at least one SR. The UE may transmit the BSR or the at least one SR to the base station 704. The base station 704 may receive the BSR or the at least one SR from the UE 702. The BSR or the at least one SR may correspond to at least one of data traffic or discovery signaling. In some aspects, a buffer size of a discovery message and data traffic of the BSR may be different. In some aspects, the BSR may comprise an LCG indicating that a buffer size of the BSR corresponds to a discovery message. The LCG may comprise an LCG ID, wherein the LCG ID is fixed or configurable. In some aspects, the BSR may comprise a fixed LCID to indicate that the BSR corresponds to a discovery message. The BSR may comprise a buffer size comprising one field, wherein a logical channel for discovery is fixed. In some aspects, the at least one SR may be configured to provide priority information that corresponds to the discovery signaling. In some aspects, the at least one SR may be associated with a logical channel for discovery. In some aspects, the at least one SR may comprise two or more SR configurations associated with a logical channel for discovery. Different SRs may be configured with a different priority for discovery. In some aspects, the BSR may comprise a destination ID, wherein the destination ID indicates that the BSR corresponds to at least one of the data traffic or the discovery signaling. The destination ID may comprise at least one value, wherein different destination IDs are assigned different priority values.

As illustrated at 708, the base station 704 may configure an uplink grant for the UE 702. The base station may configure the uplink grant for the UE using shared pool of resources or dedicated pool of resources. The base station may configure the uplink grant for the UE using shared pool of resources or dedicated pool of resources based at least on the BSR or the at least one SR. In some aspects, logical channels corresponding to the discovery signaling may be transmitted separate from non-discovery logical channels in the dedicated pool of resources.

As illustrated at 710, the base station 704 may select the shared pool of resources or the dedicated pool of resources for the uplink grant. The base station may select the shared pool of resources or the dedicated pool of resources for the uplink grant based on the BSR or the SR. In some aspects, a buffer size of a discovery message and data traffic of the BSR are different. In some aspects, the BSR may comprise a logical channel group (LCG) indicating that a buffer size of the BSR corresponds to a discovery message. The LCG may comprise an LCG identifier (ID), wherein the LCG ID may be fixed or configurable. In some aspects, the BSR may comprise a fixed logical channel identifier (LCID) to indicate that the BSR corresponds to a discovery message. The BSR may comprises a buffer size comprising one field, wherein a logical channel for discovery is fixed. In some aspects, the at least one SR may be configured to provide priority information that corresponds to the discovery signaling. In some aspects, the at least one SR may be associated with a logical channel for discovery. In some aspects, the at least one SR may comprise two or more SR configurations associated with a logical channel for discovery. Different SRs may be configured with a different priority for discovery.

As illustrated at 712, the base station 704 may the base station may transmit the uplink grant. The base station may transmit the uplink grant to the UE 702. The UE 702 may receive the uplink grant from the base station 704. The uplink grant may allocate resources for the UE 702 to communicate with a wireless device via sidelink.

As illustrated at 714, the UE 702 may communicate with a wireless device (not shown) based on the uplink grant. In some aspects, the UE may communicate via sidelink communication with the wireless device. The wireless device may comprise another UE. In some aspects, logical channels corresponding to the discovery signaling are transmitted separate from non-discovery logical channels in the dedicated pool of resources.

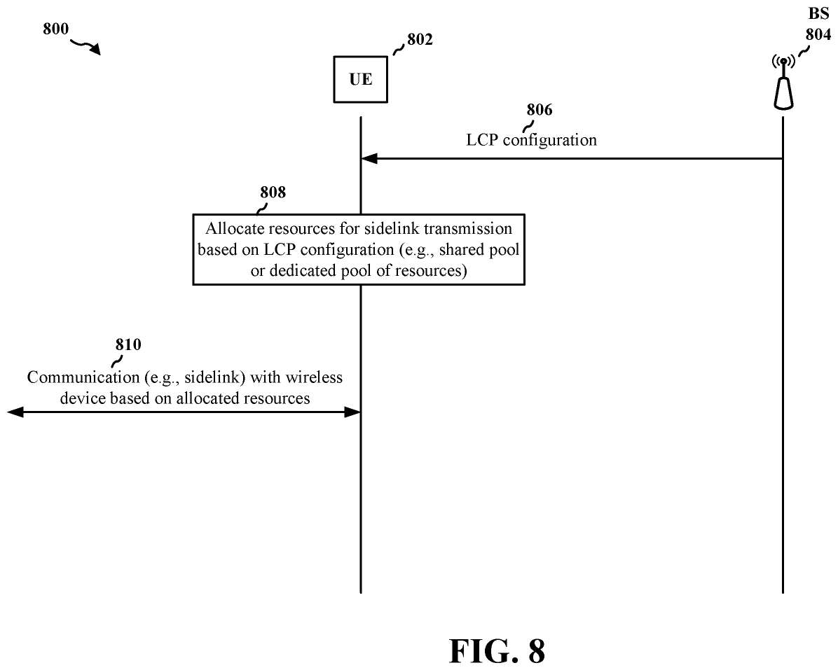

FIG. 8 is a call flow diagram 800 of signaling between a UE 802 and a base station 804. The base station 804 may be configured to provide at least one cell. The UE 802 may be configured to communicate with the base station 804. For example, in the context of FIG. 1, the base station 804 may correspond to base station 102/180 and, accordingly, the cell may include a geographic coverage area 110 in which communication coverage is provided and/or small cell 102′ having a coverage area 110′. Further, a UE 802 may correspond to at least UE 104. In another example, in the context of FIG. 3, the base station 804 may correspond to base station 310 and the UE 802 may correspond to UE 350.

As illustrated at 806, the base station 804 may transmit a logical channel prioritization (LCP) configuration to the UE 802. The UE 802 may receive the LCP configuration from the base station 804. The LCP configuration may include a restriction on dedicated pool of resources for discover. For example, the LCP may indicate that discovery logical channels cannot be multiplex with other non-discovery logical channels in the dedicated pool of resources.

As illustrated at 808, the UE 802 may allocate resources for sidelink transmission. The UE may allocate resources for sidelink transmission based on the LCP configuration. The UE may allocate resources on its own without receiving a grant from the base station. The allocated resources for the sidelink transmission may be comprised of shared pool of resources or dedicated pool of resources. In some aspects, the dedicated pool of resources may comprise discovery logical channels. The discovery logical channels may be prioritized over the shared pool of resources comprising non-discovery logical channels.

As illustrated at 810, the UE 802 may communicate with a wireless device (not shown) based on the allocated resources. The wireless device may comprise a UE. The UE 802 may communicate with the wireless device based on the allocated resources configured by the UE 802. In some aspects, logical channels corresponding to discovery signaling may be transmitted separate from non-discovery logical channels in the dedicated pool of resources.

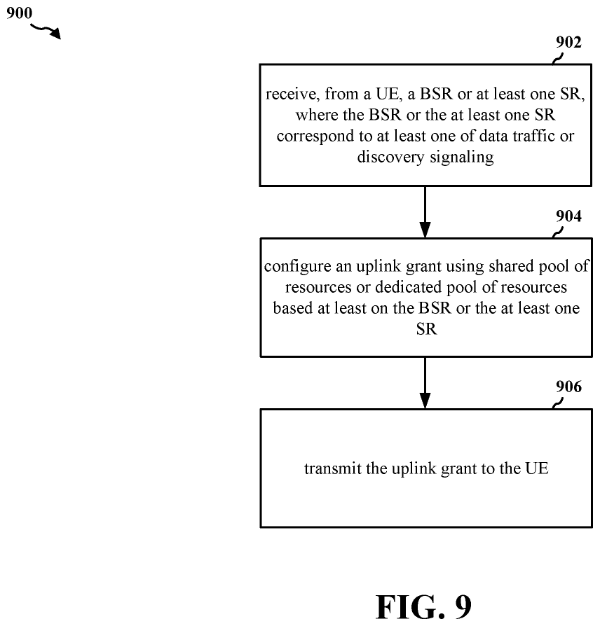

FIG. 9 is a flowchart 900 of a method of wireless communication. The method may be performed by a base station or a component of a base station (e.g., the base station 102/180; the apparatus 1102; the baseband unit 1104, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to allocate resources for a UE using shared pool of resources or dedicated pool of resources based at least on BSR or SR.

At 902, the base station may receive a BSR or at least one SR. For example, 902 may be performed by BSR/SR component 1140 of apparatus 1102. The base station may receive the BSR or the at least one SR from the UE. The BSR or the at least one SR may correspond to at least one of data traffic or discovery signaling. In some aspects, the BSR may comprise a destination identifier (ID). The destination ID may indicate that the BSR corresponds to at least one of the data traffic or the discovery signaling. In some aspects, the destination ID may comprise at least one value, wherein different destination IDs may be assigned different priority values. In some aspects, the destination ID may be forwarded to the base station from an AMF. For example, the base station may receive the destination ID from the AMF in a next generation application protocol (NGAP) message. In some aspects, the destination ID may be updated in a configuration update procedure. The configuration update procedure may be triggered by a UE policy association establishment or a UE policy association modification.

At 904, the base station may configure an uplink grant for the UE. For example, 904 may be performed by configure component 1142 of apparatus 1102. The base station may configure the uplink grant for the UE using shared pool of resources or dedicated pool of resources. The base station may configure the uplink grant for the UE using shared pool of resources or dedicated pool of resources based at least on the BSR or the at least one SR. In some aspects, logical channels corresponding to the discovery signaling may be transmitted separate from non-discovery logical channels in the dedicated pool of resources.

At 906, the base station may transmit the uplink grant. For example, 906 may be performed by grant component 1146 of apparatus 1102. The base station may transmit the uplink grant to the UE.

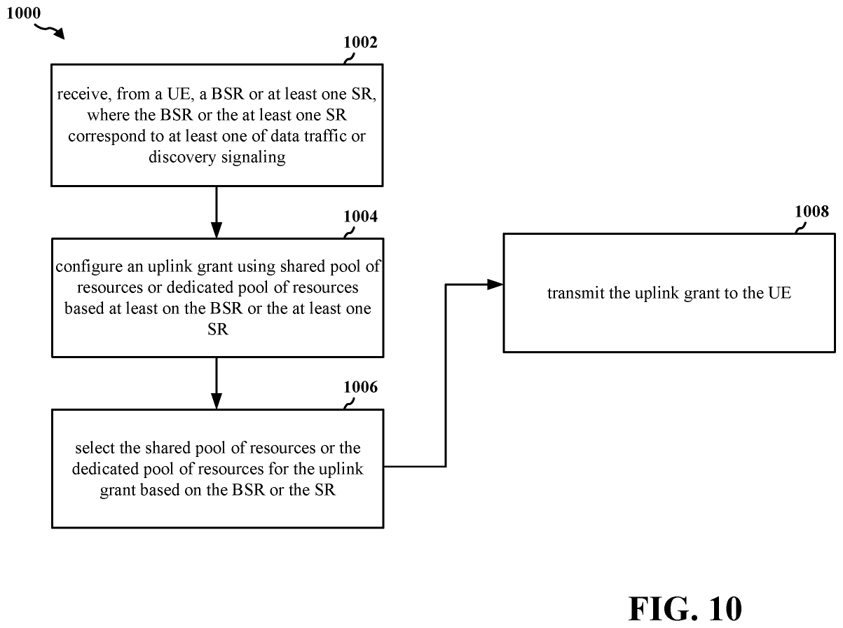

FIG. 10 is a flowchart 1000 of a method of wireless communication. The method may be performed by a base station or a component of a base station (e.g., the base station 102/180; the apparatus 1102; the baseband unit 1104, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to allocate resources for a UE using shared pool of resources or dedicated pool of resources based at least on BSR or SR.

At 1002, the base station may receive a BSR or at least one SR. For example, 1002 may be performed by BSR/SR component 1140 of apparatus 1102. The base station may receive the BSR or the at least one SR from the UE. The BSR or the at least one SR may correspond to at least one of data traffic or discovery signaling. In some aspects, the BSR may comprise a destination ID. The destination ID may indicate that the BSR corresponds to at least one of the data traffic or the discovery signaling. In some aspects, the destination ID may comprise at least one value, wherein different destination IDs may be assigned different priority values. In some aspects, the destination ID may be forwarded to the base station from an AMF. For example, the base station may receive the destination ID from the AMF in a NGAP message. In some aspects, the destination ID may be updated in a configuration update procedure. The configuration update procedure may be triggered by a UE policy association establishment or a UE policy association modification.

At 1004, the base station may configure an uplink grant for the UE. For example, 1004 may be performed by configure component 1142 of apparatus 1102. The base station may configure the uplink grant for the UE using shared pool of resources or dedicated pool of resources. The base station may configure the uplink grant for the UE using shared pool of resources or dedicated pool of resources based at least on the BSR or the at least one SR. In some aspects, logical channels corresponding to the discovery signaling may be transmitted separate from non-discovery logical channels in the dedicated pool of resources.

At 1006, the base station may select the shared pool of resources or the dedicated pool of resources for the uplink grant. For example, 1006 may be performed by selection component 1144 of apparatus 1102. The base station may select the shared pool of resources or the dedicated pool of resources for the uplink grant based on the BSR or the SR. In some aspects, a buffer size of a discovery message and data traffic of the BSR are different. In some aspects, the BSR may comprise an LCG indicating that a buffer size of the BSR corresponds to a discovery message. The LCG may comprise an LCG ID, wherein the LCG ID may be fixed or configurable. In some aspects, the BSR may comprise a fixed LCID to indicate that the BSR corresponds to a discovery message. The BSR may comprises a buffer size comprising one field, wherein a logical channel for discovery is fixed. In some aspects, the at least one SR may be configured to provide priority information that corresponds to the discovery signaling.

In some aspects, the at least one SR may be associated with a logical channel for discovery. In some aspects, the at least one SR may comprise two or more SR configurations associated with a logical channel for discovery. Different SRs may be configured with a different priority for discovery.

At 1008, the base station may transmit the uplink grant. For example, 1008 may be performed by grant component 1146 of apparatus 1102. The base station may transmit the uplink grant to the UE.

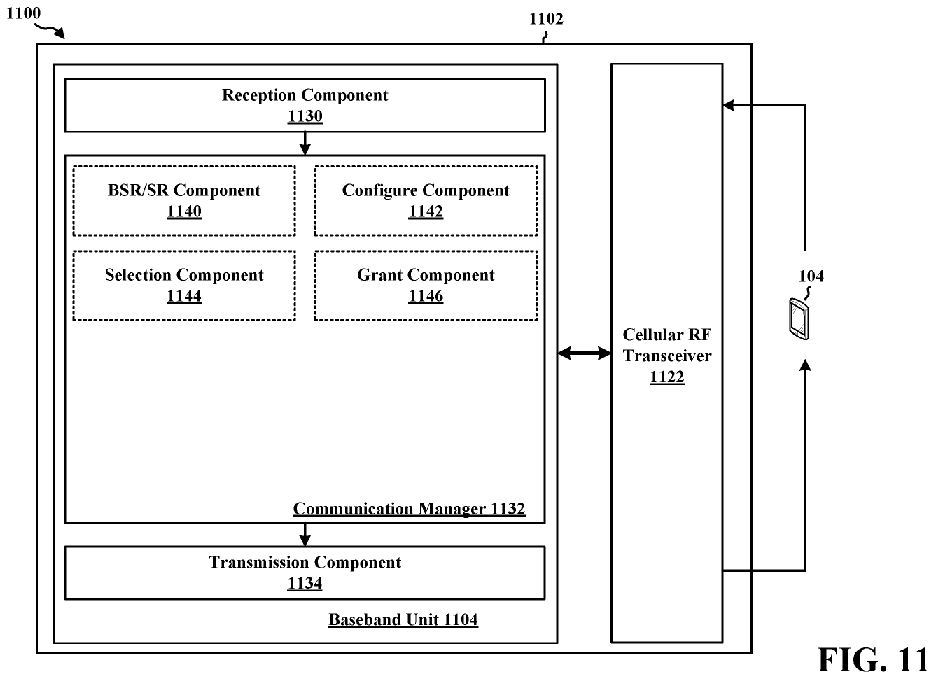

FIG. 11 is a diagram 1100 illustrating an example of a hardware implementation for an apparatus 1102. The apparatus 1102 may be a base station, a component of a base station, or may implement base station functionality. In some aspects, the apparatus 1102 may include a baseband unit 1104. The baseband unit 1104 may communicate through a cellular RF transceiver 1122 with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the base station 310 and may include the memory 376 and/or at least one of the TX processor 316, the RX processor 370, and the controller/processor 375.

The communication manager 1132 includes a BSR/SR component 1140 that may receive a BSR or at least one SR, e.g., as described in connection with 902 of FIG. 9 or 1002 of FIG. 10. The communication manager 1132 further includes a configure component 1142 that may configure an uplink grant for the UE, e.g., as described in connection with 904 of FIG. 9 or 1004 of FIG. 10. The communication manager 1132 further includes a selection component 1144 that may select the shared pool of resources or the dedicated pool of resources for the uplink grant, e.g., as described in connection with 1006 of FIG. 10. The communication manager 1132 further includes a grant component 1146 that may transmit the uplink grant, e.g., as described in connection with 906 of FIG. 9 or 1008 of FIG. 10.

The apparatus may include additional components that perform each of the blocks of the algorithm in the flowcharts of FIG. 9 or 10. As such, each block in the flowcharts of FIG. 9 or 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the baseband unit 1104, includes means for receiving, from a UE, a BSR or at least one SR. The BSR or the at least one SR correspond to at least one of data traffic or discovery signaling. The apparatus includes means for configuring an uplink grant using shared pool of resources or dedicated pool of resources based at least on the BSR or the at least one SR. The apparatus includes means for transmitting the uplink grant to the UE. The apparatus further includes means for selecting the shared pool of resources or the dedicated pool of resources for the uplink grant based on the BSR or the SR. The means may be one or more of the components of the apparatus 1102 configured to perform the functions recited by the means. As described supra, the apparatus 1102 may include the TX Processor 316, the RX Processor 370, and the controller/processor 375. As such, in one configuration, the means may be the TX Processor 316, the RX Processor 370, and the controller/processor 375 configured to perform the functions recited by the means.

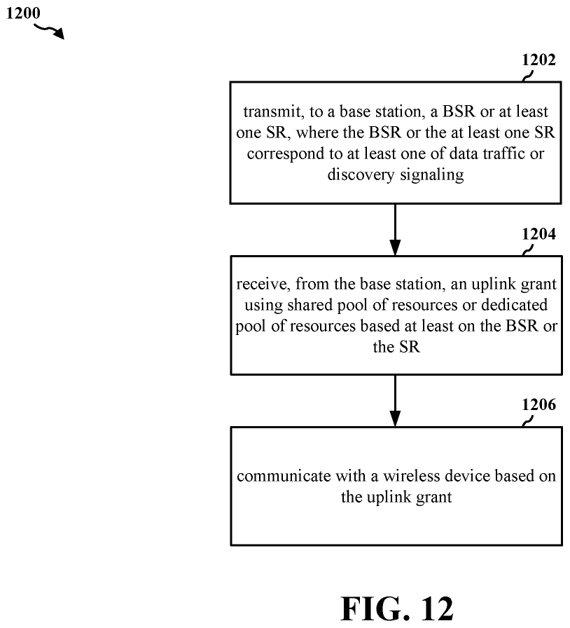

FIG. 12 is a flowchart 1200 of a method of wireless communication. The method may be performed by a UE or a component of a UE (e.g., the UE 104; the apparatus 1402; the cellular baseband processor 1404, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may receive allocated resources from a base station using shared pool of resources or dedicated pool of resources based at least on BSR or SR.

At 1202, the UE may transmit a BSR or at least one SR. For example, 1202 may be performed by BSR/SR component 1440 of apparatus 1402. The UE may transmit the BSR or the at least one SR to a base station. The BSR or the at least one SR may correspond to at least one of data traffic or discovery signaling. In some aspects, a buffer size of a discovery message and data traffic of the BSR may be different. In some aspects, the BSR may comprise an LCG indicating that a buffer size of the BSR corresponds to a discovery message. The LCG may comprise an LCG ID, wherein the LCG ID is fixed or configurable. In some aspects, the BSR may comprise a fixed LCID to indicate that the BSR corresponds to a discovery message. The BSR may comprise a buffer size comprising one field, wherein a logical channel for discovery is fixed. In some aspects, the at least one SR may be configured to provide priority information that corresponds to the discovery signaling. In some aspects, the at least one SR may be associated with a logical channel for discovery. In some aspects, the at least one SR may comprise two or more SR configurations associated with a logical channel for discovery. Different SRs may be configured with a different priority for discovery. In some aspects, the BSR may comprise a destination ID, wherein the destination ID indicates that the BSR corresponds to at least one of the data traffic or the discovery signaling. The destination ID may comprise at least one value, wherein different destination IDs are assigned different priority values.

At 1204, the UE may receive an uplink grant. For example, 1204 may be performed by grant component 1442 of apparatus 1402. The UE may receive the uplink grant from the base station. The uplink grant may use shared pool of resources or dedicated pool of resources. The uplink grant may use the shared pool of resources or the dedicated pool of resources based at least on the BSR or the SR.

At 1206, the UE may communicate with a wireless device based on the uplink grant. For example, 1206 may be performed by communication component 1448 of apparatus 1402. In some aspects, the UE may communicate via sidelink communication with the wireless device. In some aspects, logical channels corresponding to the discovery signaling are transmitted separate from non-discovery logical channels in the dedicated pool of resources.

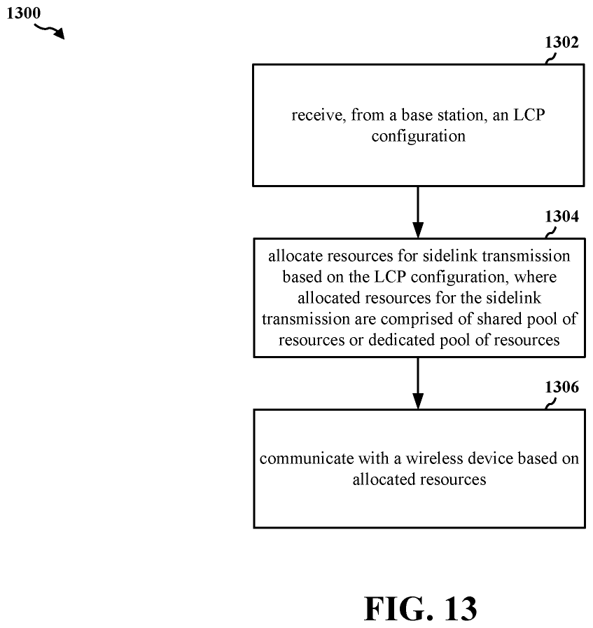

FIG. 13 is a flowchart 1300 of a method of wireless communication. The method may be performed by a UE or a component of a UE (e.g., the UE 104; the apparatus 1402; the cellular baseband processor 1404, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to allocate resources autonomously for sidelink transmission from shared pool or dedicate pool of resources based on an LCP configuration.

At 1302, the UE may receive an LCP configuration. For example, 1302 may be performed by LCP component 1444 of apparatus 1402. The UE may receive the LCP configuration from a base station.

At 1304, the UE may allocate resources for sidelink transmission. For example, 1304 may be performed by allocation component 1446 of apparatus 1402. The UE may allocate resources for sidelink transmission based on the LCP configuration. The allocated resources for the sidelink transmission may be comprised of shared pool of resources or dedicated pool of resources. In some aspects, the dedicated pool of resources may comprise discovery logical channels. The discovery logical channels may be prioritized over the shared pool of resources comprising non-discovery logical channels.

At 1306, the UE may communicate with a wireless device based on the allocated resources. For example, 1306 may be performed by communication component 1448 of apparatus 1402. In some aspects, logical channels corresponding to discovery signaling may be transmitted separate from non-discovery logical channels in the dedicated pool of resources.

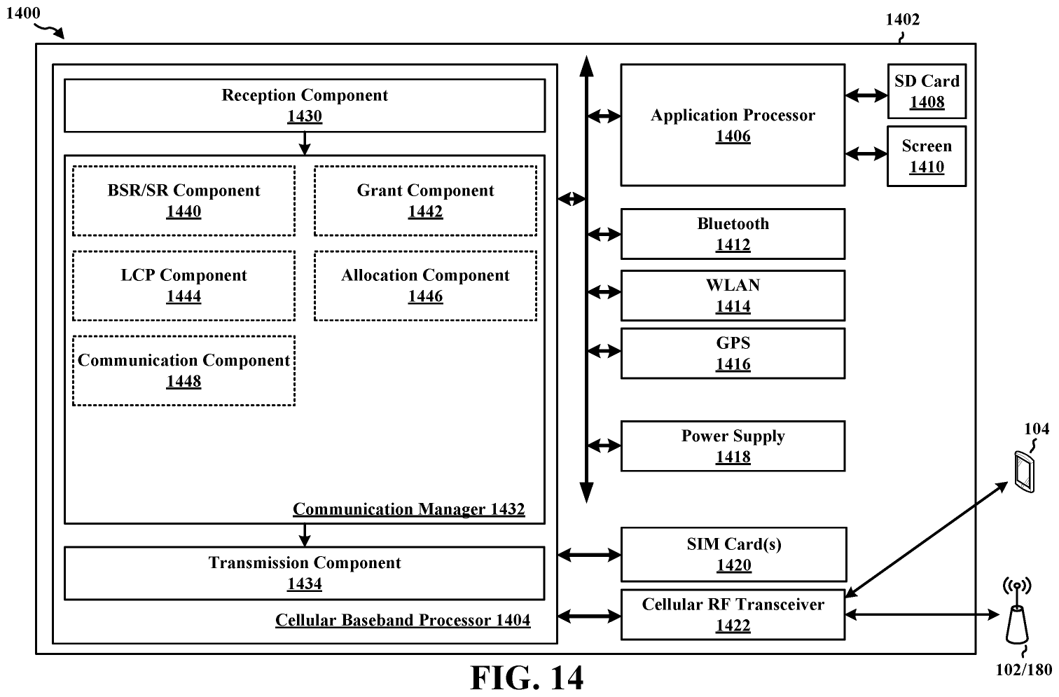

FIG. 14 is a diagram 1400 illustrating an example of a hardware implementation for an apparatus 1402. The apparatus 1402 may be a UE, a component of a UE, or may implement UE functionality. In some aspects, the apparatus 1402 may include a cellular baseband processor 1404 (also referred to as a modem) coupled to a cellular RF transceiver 1422. In some aspects, the apparatus 1402 may further include one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, or a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 350 of FIG. 3) and include the additional modules of the apparatus 1402. The communication manager 1432 includes a BSR/SR component 1440 that is configured to transmit a BSR or at least one SR, e.g., as described in connection with 1202 of FIG. 12. The communication manager 1432 further includes a grant component 1442 that is configured to receive an uplink grant, e.g., as described in connection with 1204 of FIG. 12. The communication manager 1432 further includes an LCP component 1444 that is configured to receive an LCP configuration, e.g., as described in connection with 1302 of FIG. 13. The communication manager 1432 further includes an allocation component 1446 that is configured to allocate resources for sidelink transmission, e.g., as described in connection with 1304 of FIG. 13. The communication manager 1432 further includes a communication component 1448 that is configured to communicate with a wireless device based on the uplink grant, e.g., as described in connection with 1206 of FIG. 12. The communication component 1448 may be configured to communicate with a wireless device based on the allocated resources, e.g., as described in connection with 1306 of FIG. 13.

The apparatus may include additional components that perform each of the blocks of the algorithm in the flowcharts of FIG. 12 or 13. As such, each block in the flowcharts of FIG. 12 or 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the cellular baseband processor 1404, includes means for transmitting, to a base station, a BSR or at least one SR. The BSR or the at least one SR correspond to at least one of data traffic or discovery signaling. The apparatus includes means for receiving, from the base station, an uplink grant using shared pool of resources or dedicated pool of resources based at least on the BSR or the SR. The apparatus includes means for communicating with a wireless device based on the uplink grant. The apparatus includes means for receiving, from a base station, an LCP configuration. The apparatus includes means for allocating resources for sidelink transmission based on the LCP configuration. Allocated resources for the sidelink transmission are comprised of shared pool of resources or dedicated pool of resources. The apparatus includes means for communicating with a wireless device based on allocated resources. The means may be one or more of the components of the apparatus 1402 configured to perform the functions recited by the means. As described supra, the apparatus 1402 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to receive, from a UE, a BSR or at least one SR, wherein the BSR or the at least one SR correspond to at least one of data traffic or discovery signaling; configure an uplink grant using shared pool of resources or dedicated pool of resources based at least on the BSR or the at least one SR; and transmit the uplink grant to the UE.

Aspect 2 is the apparatus of aspect 1, further including a transceiver coupled to the at least one processor.

Aspect 3 is the apparatus of any of aspects 1 and 2, further includes that the at least one processor is further configured to select the shared pool of resources or the dedicated pool of resources for the uplink grant based on the BSR or the SR.

Aspect 4 is the apparatus of any of aspects 1-3, further includes that a buffer size of a discovery message and data traffic of the BSR are different.

Aspect 5 is the apparatus of any of aspects 1-4, further includes that the BSR comprises an LCG indicating that a buffer size of the BSR corresponds to a discovery message, wherein the LCG comprises an LCG ID, wherein the LCG ID is fixed or configured.

Aspect 6 is the apparatus of any of aspects 1-5, further includes that the BSR comprises a fixed LCID to indicate that the BSR corresponds to a discovery message, wherein the BSR comprises a buffer size comprising one field, wherein a logical channel for discovery is fixed.

Aspect 7 is the apparatus of any of aspects 1-6, further includes that the at least one SR is configured to provide priority information that corresponds to the discovery signaling.

Aspect 8 is the apparatus of any of aspects 1-7, further includes that the at least one SR is associated with a logical channel for discovery.

Aspect 9 is the apparatus of any of aspects 1-8, further includes that the at least one SR comprises two or more SR configurations associated with a logical channel for discovery, wherein different SR are configured with a different priority for discovery.

Aspect 10 is the apparatus of any of aspects 1-9, further includes that the BSR comprises a destination ID, wherein the destination ID indicates that the BSR corresponds to at least one of the data traffic or the discovery signaling.

Aspect 11 is the apparatus of any of aspects 1-10, further includes that the destination ID comprises at least one value, wherein different destination IDs are assigned different priority values.

Aspect 12 is the apparatus of any of aspects 1-11, further includes that the destination ID is forwarded to the base station from an AMF.

Aspect 13 is the apparatus of any of aspects 1-12, further includes that the destination ID is updated in a Configuration Update procedure.

Aspect 14 is the apparatus of any of aspects 1-13, further includes that logical channels corresponding to the discovery signaling are transmitted separate from non-discovery logical channels in the dedicated pool of resources.

Aspect 15 is a method of wireless communication for implementing any of aspects 1-14.

Aspect 16 is an apparatus for wireless communication including means for implementing any of aspects 1-14.

Aspect 17 is a computer-readable medium storing computer executable code, where the code when executed by a processor causes the processor to implement any of aspects 1-14.

Aspect 18 is an apparatus for wireless communication including at least one processor coupled to a memory and configured to transmit, to a base station, a BSR or at least one SR, wherein the BSR or the at least one SR correspond to at least one of data traffic or discovery signaling; receive, from the base station, an uplink grant using shared pool of resources or dedicated pool of resources based at least on the BSR or the SR; and communicate with a wireless device based on the uplink grant.

Aspect 19 is the apparatus of aspect 18, further including a transceiver coupled to the at least one processor.

Aspect 20 is the apparatus of any of aspects 18 and 19, further includes that a buffer size of a discovery message and data traffic of the BSR are different.

Aspect 21 is the apparatus of any of aspects 18-20, further includes that the BSR comprises an LCG indicating that a buffer size of the BSR corresponds to a discovery message, wherein the LCG comprises an LCG ID, wherein the LCG ID is fixed or configured.

Aspect 22 is the apparatus of any of aspects 18-21, further includes that the BSR comprises a fixed LCID to indicate that the BSR corresponds to a discovery message, wherein the BSR comprises a buffer size comprising one field, wherein a logical channel for discovery is fixed.

Aspect 23 is the apparatus of any of aspects 18-22, further includes that the at least one SR is configured to provide priority information that corresponds to the discovery signaling.

Aspect 24 is the apparatus of any of aspects 18-23, further includes that the at least one SR is associated with a logical channel for discovery.

Aspect 25 is the apparatus of any of aspects 18-24, further includes that the at least one SR comprises two or more SR configurations associated with a logical channel for discovery, wherein different SR are configured with a different priority for discovery.

Aspect 26 is the apparatus of any of aspects 18-25, further includes that the BSR comprises a destination ID, wherein the destination ID indicates that the BSR corresponds to at least one of the data traffic or the discovery signaling.

Aspect 27 is the apparatus of any of aspects 18-26, further includes that the destination ID comprises at least one value, wherein different destination IDs are assigned different priority values.

Aspect 28 is the apparatus of any of aspects 18-27, further includes that logical channels corresponding to the discovery signaling are transmitted separate from non-discovery logical channels in the dedicated pool of resources.

Aspect 29 is a method of wireless communication for implementing any of aspects 18-28.

Aspect 30 is an apparatus for wireless communication including means for implementing any of aspects 18-28.

Aspect 31 is a computer-readable medium storing computer executable code, where the code when executed by a processor causes the processor to implement any of aspects 18-28.

Aspect 32 is an apparatus for wireless communication including at least one processor coupled to a memory and configured to receive, from a base station, an LCP configuration; allocate resources for sidelink transmission based on the LCP configuration, wherein allocated resources for the sidelink transmission are comprised of shared pool of resources or dedicated pool of resources; and communicate with a wireless device based on allocated resources.

Aspect 33 is the apparatus of aspect 32, further including a transceiver coupled to the at least one processor.

Aspect 34 is the apparatus of any of aspects 32 and 33, further includes that logical channels corresponding to discovery signaling are transmitted separate from non-discovery logical channels in the dedicated pool of resources.

Aspect 35 is the apparatus of any of aspects 32-34, further includes that the dedicated pool of resources comprising discovery logical channels are prioritized over the shared pool of resources comprising non-discovery logical channels.

Aspect 36 is a method of wireless communication for implementing any of aspects 32-35.

Aspect 37 is an apparatus for wireless communication including means for implementing any of aspects 32-35.

Aspect 38 is a computer-readable medium storing computer executable code, where the code when executed by a processor causes the processor to implement any of aspects 32-35.

1. An apparatus for wireless communication at a base station, comprising:
a memory; and
at least one processor coupled to the memory and configured to:
receive, from a user equipment (UE), a buffer status report (BSR) or at least one scheduling request (SR), wherein the BSR or the at least one SR correspond to at least one of data traffic or discovery signaling;
configure an uplink grant using shared pool of resources or dedicated pool of resources based at least on the BSR or the at least one SR; and
transmit the uplink grant to the UE.

2. (canceled)

3. The apparatus of claim 1, wherein the at least one processor is further configured to:
select the shared pool of resources or the dedicated pool of resources for the uplink grant based on the BSR or the SR.

4. The apparatus of claim 3, wherein a buffer size of a discovery message and data traffic of the BSR are different.

5. The apparatus of claim 3, wherein the BSR comprises a logical channel group (LCG) indicating that a buffer size of the BSR corresponds to a discovery message, wherein the LCG comprises an LCG identifier (ID), wherein the LCG ID is fixed or configured.

6. The apparatus of claim 3, wherein the BSR comprises a fixed logical channel identifier (LCID) to indicate that the BSR corresponds to a discovery message, wherein the BSR comprises a buffer size comprising one field, wherein a logical channel for discovery is fixed.

7. The apparatus of claim 3, wherein the at least one SR is configured to provide priority information that corresponds to the discovery signaling.

8. The apparatus of claim 3, wherein the at least one SR is associated with a logical channel for discovery.

9. The apparatus of claim 3, wherein the at least one SR comprises two or more SR configurations associated with a logical channel for discovery, wherein different SR are configured with a different priority for discovery.

10. The apparatus of claim 1, wherein the BSR comprises a destination identifier (ID), wherein the destination ID indicates that the BSR corresponds to at least one of the data traffic or the discovery signaling.

11. The apparatus of claim 10, wherein the destination ID comprises at least one value, wherein different destination IDs are assigned different priority values.

12. The apparatus of claim 10, wherein the destination ID is forwarded to the base station from an access and mobility management function (AMF).

13. The apparatus of claim 10, wherein the destination ID is updated in a Configuration Update procedure.

14. The apparatus of claim 1, wherein logical channels corresponding to the discovery signaling are transmitted separate from non-discovery logical channels in the dedicated pool of resources.

15. An apparatus for wireless communication at a user equipment (UE), comprising:
a memory; and
at least one processor coupled to the memory and configured to:
transmit, to a base station, a buffer status report (BSR) or at least one scheduling request (SR), wherein the BSR or the at least one SR correspond to at least one of data traffic or discovery signaling;
receive, from the base station, an uplink grant using shared pool of resources or dedicated pool of resources based at least on the BSR or the SR; and
communicate with a wireless device based on the uplink grant.

16. (canceled)

17. The apparatus of claim 15, wherein a buffer size of a discovery message and data traffic of the BSR are different.

18. The apparatus of claim 15, wherein the BSR comprises a logical channel group (LCG) indicating that a buffer size of the BSR corresponds to a discovery message, wherein the LCG comprises an LCG identifier (ID), wherein the LCG ID is fixed or configured.

19. The apparatus of claim 15, wherein the BSR comprises a fixed logical channel identifier (LCID) to indicate that the BSR corresponds to a discovery message, wherein the BSR comprises a buffer size comprising one field, wherein a logical channel for discovery is fixed.

20. The apparatus of claim 15, wherein the at least one SR is configured to provide priority information that corresponds to the discovery signaling.

21. The apparatus of claim 15, wherein the at least one SR is associated with a logical channel for discovery.

22. The apparatus of claim 15, wherein the at least one SR comprises two or more SR configurations associated with a logical channel for discovery, wherein different SR are configured with a different priority for discovery.

23. The apparatus of claim 15, wherein the BSR comprises a destination identifier (ID), wherein the destination ID indicates that the BSR corresponds to at least one of the data traffic or the discovery signaling.

24. The apparatus of claim 23, wherein the destination ID comprises at least one value, wherein different destination IDs are assigned different priority values.

25. The apparatus of claim 15, wherein logical channels corresponding to the discovery signaling are transmitted separate from non-discovery logical channels in the dedicated pool of resources.

26. An apparatus for wireless communication at a user equipment (UE), comprising:
a memory; and
at least one processor coupled to the memory and configured to:
receive, from a base station, a logical channel prioritization (LCP) configuration;
allocate resources for sidelink transmission based on the LCP configuration, wherein allocated resources for the sidelink transmission are comprised of shared pool of resources or dedicated pool of resources; and
communicate with a wireless device based on allocated resources.

27. (canceled)

28. The apparatus of claim 26, wherein logical channels corresponding to discovery signaling are transmitted separate from non-discovery logical channels in the dedicated pool of resources.

29. The apparatus of claim 26, wherein the dedicated pool of resources comprising discovery logical channels are prioritized over the shared pool of resources comprising non-discovery logical channels.

30. A method of wireless communication at a base station, comprising:
receiving, from a user equipment (UE), a buffer status report (BSR) or at least one scheduling request (SR), wherein the BSR or the at least one SR are configured to correspond to at least one of data traffic or discovery signaling;
configuring an uplink grant using shared pool of resources or dedicated pool of resources based at least on the BSR or the at least one SR; and
transmitting the uplink grant to the UE.

31. The apparatus of claim 26, further comprising a transceiver coupled to the at least one processor, the transceiver configured to:
receive, from the base station, the LCP configuration; and
communicate with the wireless device based on the allocated resources.

32. The apparatus of claim 26, wherein logical channels corresponding to discovery signaling are not multiplexed with non-discovery logical channels in the dedicated pool of resources.

33. The apparatus of claim 26, wherein to allocate the resources for the sidelink transmission, the at least one processor is configured to:
prioritize a selection of the dedicated pool of resources having discovery logical channels over the shared pool of resources having non-discovery logical channels.
